(19) United States
(12) Patent Application Publication
(10) Pub. No.: US 2010/0073809 A1
(43) Pub. Date: Mar. 25, 2010

(54) X-AMR ASSISTED RECORDING ON HIGH DENSITY BPM MEDIA

(75) Inventors: Hans Jurgen Richter, Palo Alto, CA (US); Dieter Klaus Weller, San Jose, CA (US); Samuel Dacke Harkness, Berkeley, CA (US); Alexander Yulievich Dobin, Milpitas, CA (US)

Correspondence Address: Seagate Technology LLC, 920 Disc Drive, Scotts Valley, CA, 95066, US

(73) Assignee: Seagate Technology LLC, Scotts Valley, CA (US)

(21) Appl. No.: 12/238,295

(22) Filed: Sep. 25, 2008

(51) Int. Cl. G11B 5/596

(52) U.S. Cl. 360/77.02; G9B/5.216

(57) ABSTRACT

A method of writing information to an area of a bit-patterned medium, in which a magnetized probe generates a magnetic probe field at the area of bit-patterned medium to be written, applying an oriented static magnetic field, and applying an oriented microwave field at a selected frequency, resulting in the writing of information onto the area of bit-patterned media.

### RELATED APPLICATIONS

None.

### BACKGROUND

A method of writing information to an area of a bit-patterned medium, in which a magnetized probe generates a magnetic probe field at the area of bit-patterned medium to be written, applying an oriented static magnetic field, and applying an oriented microwave field at a selected frequency, resulting in the writing of information onto the area of bit-patterned media.

### SUMMARY OF THE INVENTION

This invention describes an apparatus and method for recording on BPM magnetic medium, while ensuring that the memory state of adjacent BPM dots is not adversely affected. The write intensity is selected to be suitable for the characteristics of BPM media. The write assist also enables the use of higher anisotropy materials required for the smaller dots and higher densities characteristic of BPM recording media.

### B DESCRIPTION OF THE DRAWINGS

FIG. 1 is a view of a magnetic disk drive of the related art.

FIG. 2 is a schematic representation of the film structure in accordance with a magnetic recording medium of the related art.

FIG. 3 is perspective view of a magnetic head and a magnetic disk of the related art.

FIG. 4 is a schematic depiction of a portion of a conventional bit patterned recording medium of the related art.

FIG. 5 is a schematic view of the Wire-Assisted Magnetic Recording apparatus.

FIG. 6 is a schematic view of the Microwave-Assisted Magnetic Recording.

FIG. 7 sketches the resonance frequency of a single domain particle with uniaxial anisotropy as a function of applied field.

FIG. 8 depicts the microwave excitation applied at a representative head field, which can cause switching of one or more particles.

### DETAILED DESCRIPTION

This invention relates to perpendicular recording media, such as thin film magnetic recording disks having perpendicular recording, and to a method of manufacturing the media. The invention has particular applicability to high areal density magnetic recording media exhibiting low noise.

The increasing demands for higher areal recording density impose increasingly greater demands on thin film magnetic recording media in terms of remanent coercivity (Hr), magnetic remanance (Mr), coercivity squareness (S*), medium noise, i.e., signal-to-medium noise ratio (SMNR), and narrow track recording performance. It is extremely difficult to produce a magnetic recording medium satisfying such demanding requirements.

The linear recording density can be increased by increasing the Hr of the magnetic recording medium, and by decreasing the medium noise, as by maintaining very fine magnetically non-coupled grains. Medium noise in thin films is a dominant factor restricting increased recording density of high-density magnetic hard disk drives, and is attributed primarily to inhomogeneous grain size and intergranular exchange coupling. Accordingly, in order to increase linear density, medium noise must be minimized by suitable microstructure control.

According to the domain theory, a magnetic material is composed of a number of submicroscopic regions called domains. Each domain contains parallel atomic moments and is always magnetized to saturation, but the directions of magnetization of different domains are not necessarily parallel. In the absence of an applied magnetic field, adjacent domains may be oriented randomly in any number of several directions, called the directions of easy magnetization, which depend on the geometry of the crystal. The resultant effect of all these various directions of magnetization may be zero, as is the case with an unmagnetized specimen. When a magnetic filed is applied, the domains most nearly parallel to the direction of the applied field grow in size at the expense of the others. This is called boundary displacement of the domains or the domain growth. A further increase in magnetic field causes more domains to rotate and align parallel to the applied field. When the material reaches the point of saturation magnetization, no further domain growth would take place on increasing the strength of the magnetic field.

A magnetic material is said to possess a uniaxial anisotropy when all domains are oriented in the same direction in the material. On the other extreme, a magnetic material is said to be isotropic when all domains are oriented randomly.

The ease of magnetization or demagnetization of a magnetic material depends on the crystal structure, grain orientation, the state of strain, and the direction and strength of the magnetic field. The magnetization is most easily obtained along the easy axis of magnetization but most difficult along the hard axis of magnetization.

Magnetic quenching to achieve a desired magnetic orientation may be achieved using the apparatus and method described in Seagate Disclosure #3550, the contents of which are hereby incorporated by reference in their entirety.

“Anisotropy energy” is the difference in energy of magnetization for these two extreme directions, namely, the easy axis of magnetization and the hard axis of magnetization. For example, a single crystal of iron, which is made up of a cubic array of iron atoms, tends to magnetize in the directions of the cube edges along which lie the easy axes of magnetization. A single crystal of iron requires about 1.4×10⁵ ergs/cm³ (at room temperature) to move magnetization into the hard axis of magnetization, which is along a cubic body diagonal.

The anisotropy energy U_{A} could be expressed in an ascending power series of the direction cosines between the magnetization and the crystal axes. For cubic crystals, the lowest-order terms take the form of Equation (1),

U_{A}=K₁(α₁²α₂²+α₂²α₃²+α₃²α₁²)+K₂(α₁²α₂²α₃²) (1)

where α₁, α₂ and α₃ are direction cosines with respect to the cube, and K₁ and K₂ are temperature-dependent parameters characteristic of the material, called anisotropy constants.

Anisotropy constants can be determined from (1) analysis of magnetization curves, (2) the torque on single crystals in a large applied field, and (3) single crystal magnetic resonance.

The total energy of a magnetic substance depends upon the state of strain in the magnetic material and the direction of magnetization through three contributions. The first two consist of the crystalline anisotropy energy of the unstrained lattice plus a correction that takes into account the dependence of the anisotropy energy on the state of strain. The third contribution is that of the elastic energy, which is independent of magnetization direction and is a minimum in the unstrained state. The state of strain of the crystal will be that which makes the sum of the three contributions of the energy a minimum. The result is that, when magnetized, the lattice is always distorted from the unstrained state, unless there is no anisotropy.

“Magnetostriction” refers to the changes in dimension of a magnetic material when it is placed in magnetic field. It is caused by the rotation of domains of a magnetic material under the action of magnetic field. The rotation of domains gives rise to internal strains in the material, causing its contraction or expansion.

The requirements for high areal density impose increasingly greater requirements on magnetic recording media in terms of coercivity, remanent squareness, low medium noise and narrow track recording performance. It is extremely difficult to produce a magnetic recording medium satisfying such demanding requirements, particularly a high-density magnetic rigid disk medium for longitudinal and perpendicular recording. The magnetic anisotropy of longitudinal and perpendicular recording media makes the easily magnetized direction of the media located in the film plane and perpendicular to the film plane, respectively. The remanent magnetic moment of the magnetic media after magnetic recording or writing of longitudinal and perpendicular media is located in the film plane and perpendicular to the film plane, respectively.

A substrate material conventionally employed in producing magnetic recording rigid disks comprises an aluminum-magnesium (Al—Mg) alloy. Such Al—Mg alloys are typically electrolessly plated with a layer of NiP at a thickness of about 15 microns to increase the hardness of the substrates, thereby providing a suitable surface for polishing to provide the requisite surface roughness or texture.

Other substrate materials have been employed, such as glass, e.g., an amorphous glass, glass-ceramic material which comprises a mixture of amorphous and crystalline materials, and ceramic materials. Glass-ceramic materials do not normally exhibit a crystalline surface. Glasses and glass-ceramics generally exhibit high resistance to shocks.

Almost all the manufacturing of a disk media takes place in clean rooms where the amount of dust in the atmosphere is kept very low, and is strictly controlled and monitored. After one or more cleaning processes on a non-magnetic substrate, the substrate has an ultra-clean surface and is ready for the deposition of layers of magnetic media on the substrate. The apparatus for depositing all the layers needed for such media could be a static sputter system or a pass-by system, where all the layers except the lubricant are deposited sequentially inside a suitable vacuum environment.

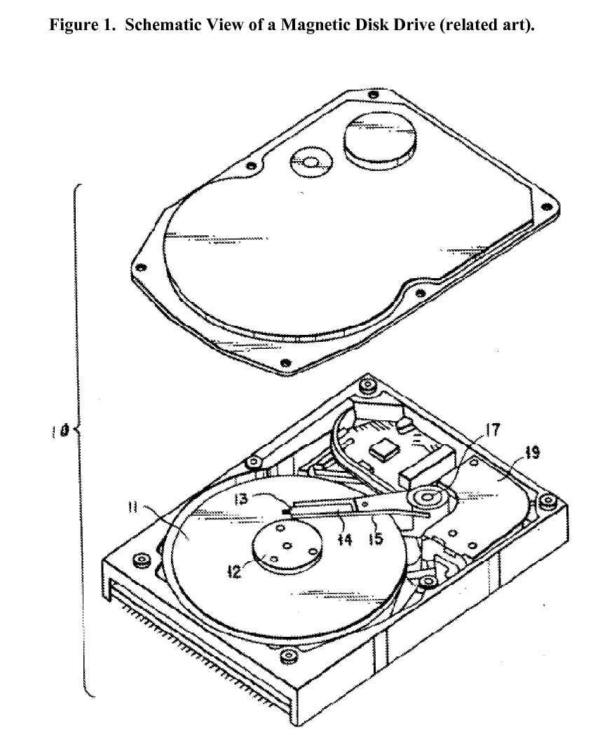

FIG. 1 shows the schematic arrangement of a magnetic disk drive 10 using a rotary actuator. A disk or medium 11 is mounted on a spindle 12 and rotated at a predetermined speed. The rotary actuator comprises an arm 15 to which is coupled a suspension 14. A magnetic head 13 is mounted at the distal end of the suspension 14. The magnetic head 13 is brought into contact with the recording/reproduction surface of the disk 11. The rotary actuator could have several suspensions and multiple magnetic heads to allow for simultaneous recording and reproduction on and from both surfaces of each medium.

An electromagnetic converting portion (not shown) for recording/reproducing information is mounted on the magnetic head 13. The arm 15 has a bobbin portion for holding a driving coil (not shown). A voice coil motor 19 as a kind of linear motor is provided to the other end of the arm 15. The voice motor 19 has the driving coil wound on the bobbin portion of the arm 15 and a magnetic circuit (not shown). The magnetic circuit comprises a permanent magnet and a counter yoke. The magnetic circuit opposes the driving coil to sandwich it. The arm 15 is swingably supported by ball bearings (not shown) provided at the upper and lower portions of a pivot portion 17. The ball bearings provided around the pivot portion 17 are held by a carriage portion (not shown).

A magnetic head support mechanism is controlled by a positioning servo driving system. The positioning servo driving system comprises a feedback control circuit having a head position detection sensor (not shown), a power supply (not shown), and a controller (not shown). When a signal is supplied from the controller to the respective power supplies based on the detection result of the position of the magnetic head 13, the driving coil of the voice coil motor 19 and the piezoelectric element (not shown) of the head portion are driven.

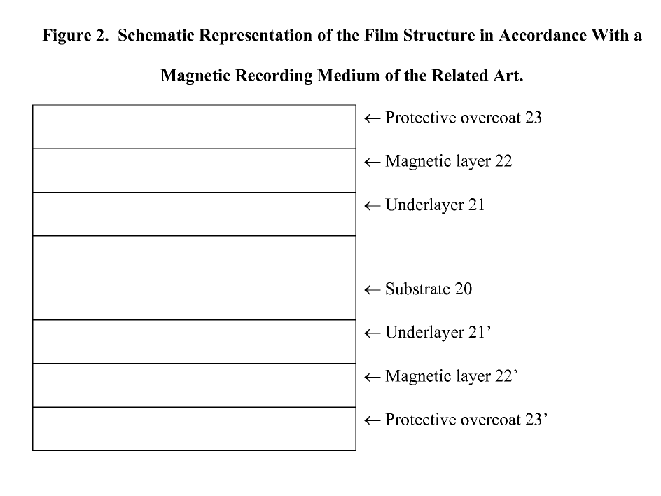

A cross sectional view of a conventional longitudinal recording disk medium is depicted in FIG. 2. A longitudinal recording medium typically comprises a non-magnetic substrate 20 having sequentially deposited on each side thereof an underlayer 21, 21′, such as chromium (Cr) or Cr-alloy, a magnetic layer 22, 22′, typically comprising a cobalt (Co)-base alloy, and a protective overcoat 23, 23′, typically containing carbon. Conventional practices also comprise bonding a lubricant topcoat (not shown) to the protective overcoat. Underlayer 21, 21′, magnetic layer 22, 22′, and protective overcoat 23, 23′, are typically deposited by sputtering techniques. The Co-base alloy magnetic layer deposited by conventional techniques normally comprises polycrystallites epitaxially grown on the polycrystal Cr or Cr-alloy underlayer.

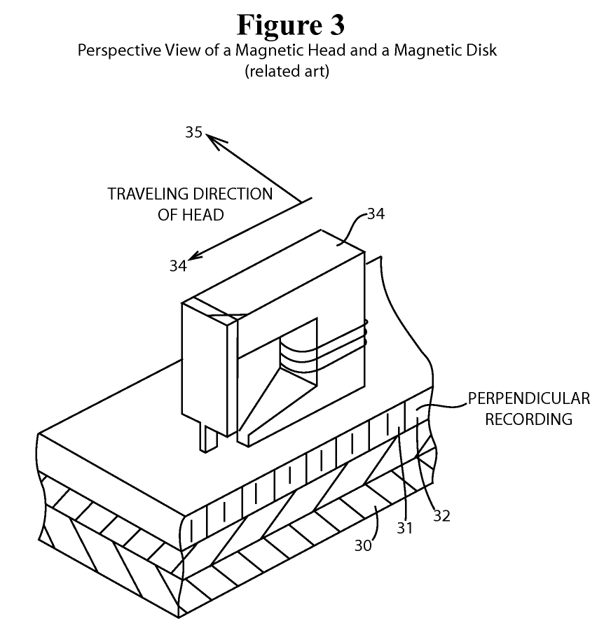

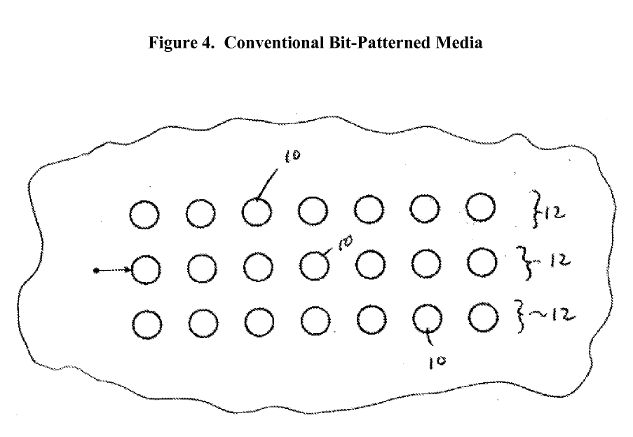

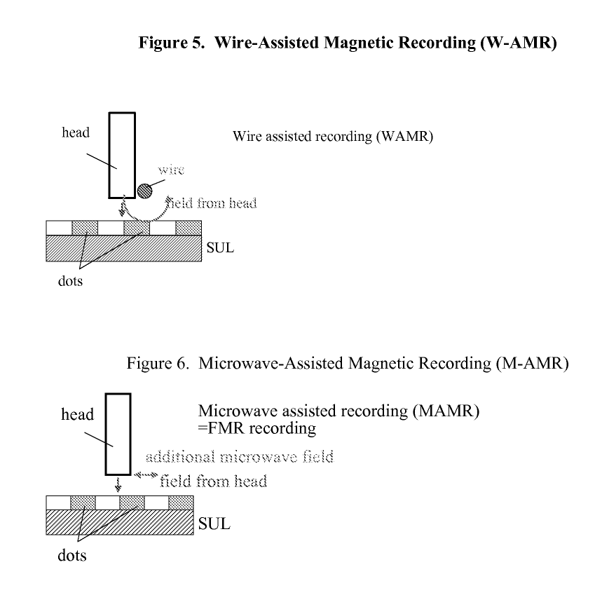

A conventional perpendicular recording disk medium, shown in FIG. 3, is similar to the longitudinal recording medium depicted in FIG. 2, but with the following differences. First, a conventional perpendicular recording disk medium has soft magnetic underlayer 31 of an alloy such as Permalloy instead of a Cr-containing underlayer. Second, as shown in FIG. 3, magnetic layer 32 of the perpendicular recording disk medium comprises domains oriented in a direction perpendicular to the plane of the substrate 30. Also, shown in FIG. 3 are the following: (a) read-write head 33 located on the recording medium, (b) traveling direction 34 of head 33 and (c) transverse direction 35 with respect to the traveling direction 34.

The underlayer and magnetic layer are conventionally sequentially sputter deposited on the substrate in an inert gas atmosphere, such as an atmosphere of pure argon. A conventional carbon overcoat is typically deposited in argon with nitrogen, hydrogen or ethylene. Conventional lubricant topcoats are typically about 20 Å thick.

It is recognized that the magnetic properties, such as Hr, Mr, S* and SMNR, which are critical to the performance of a magnetic alloy film, depend primarily upon the microstructure of the magnetic layer which, in turn, is influenced by one or more underlying layers on which it is deposited. It is also recognized that an underlayer made of soft magnetic films is useful in perpendicular recording media because a relatively thick (compared to magnetic layer) soft underlayer provides a return path for the read-write head and amplifies perpendicular component of the write field in the recording layer. However, Barkhausen noise caused by domain wall motions in the soft underlayer can be a significant noise source. Since the orientation of the domains can be controlled by the uniaxial anisotropy, introducing a uniaxial anisotropy in the soft underlayer would be one way to suppress Barkhausen noise. When the uniaxial anisotropy is sufficiently large, the domains would preferably orient themselves along the anisotropy axis.

The uniaxial anisotropy could be controlled in several ways in the soft magnetic thin film materials. The most frequently applied methods are post-deposition annealing while applying a magnetic field and applying a bias magnetic field during deposition. However, both methods can cause complications in the disk manufacturing process.

A “soft magnetic” material is material that is easily magnetized and demagnetized. As compared to a soft magnetic material, a “hard magnetic” material is one that neither magnetizes nor demagnetizes easily. The problem of making soft magnetic materials conventionally is that they usually have many crystalline boundaries and crystal grains oriented in many directions. In such metals, the magnetization process is accompanied by much irreversible Block wall motion and by much rotation against anisotropy, which is usually irreversible. See Mc-Graw Hill Encyclopedia of Science & Technology, Vol. 5, 366 (1982). Mc-Graw Hill Encyclopedia of Science & Technology further states that the preferred soft material would be a material fabricated by some inexpensive technique that results in all crystal grains being oriented in the same or nearly the same direction. Id. However, “all grains” oriented in the same direction would be very difficult to produce and would not be the “preferred soft material.” In fact, very high anisotropy is not desirable.

The magnetic layer of modern magnetic media is composed of a single sheet of very fine, single domain grains. The grain structure inherits randomness from the manufacturing process, that is, the grains neither grow in a regular pattern nor do they have identical sizes. Traditional magnetic recording deals with this randomness by averaging. Scaling has made possible dramatic increases of the areal density in magnetic recording. However, very small grains are no longer thermally stable and the maximum obtainable recording density is limited.

Related art methods of recording on magnetic media recognize that a radio frequency (RF) field may be used to assist in the writing process. See for example U.S. Pat. No. 6,011,664. However, the related art method discloses that the RF field is parallel or antiparallel to the head field and the easy axis.

Bit-Patterned Media (BPM) is a recording medium where each bit is defined by only one grain, where a grain is an area of magnetic medium having a single magnetic domain. In BPM, the relevant volumes for thermal stability considerations are significantly increased compared to conventional recording and the onset of superparamagnetism is correspondingly postponed. to higher areal densities. The superparamagnetic effect causes a lower limit for the grain size, as well as a lower limit for the signal-to-noise ratio as compared to conventional recording. See H. J. Richter et al., Recording Potential of Bit-Patterned Media, Applied Physics Letters 88, 222512 (2006), the contents of which are incorporated herein in their entirety.

An alternative to conventional recording media is bit patterned media. In bit patterned media, the bits do not contain as many grains as those in conventional media. Instead, bit patterned media comprise arrays of magnetic islands which are recorded one at a time and thus each island represents one bit. Such media structures can be manufactured by lithographical processes. The signal-to-noise ratio of a bit patterned medium is then determined by the variations of the island spacings and sizes and thus depends on the quality of the lithography process. Accordingly, the signal-to-noise ratio can be improved considerably beyond that of conventional media.

There are limits, however, to the lithography process so that the density of the islands is limited. The highest areal density is obtained when the spacings between the islands in the cross-track and the down-track directions are identical. Moreover, a recording on patterned media needs to be synchronized and therefore the bits should not be placed “bumper to bumper”.

Referring to FIG. 1, which depicts a regular array of patterned bits 10, a record or write head would be moved along a row of islands and switched or pulsed to achieve the desired recording of data. The spacing between track and bits is the same, so that the aspect ratio of one bit (the “bit aspect ratio”) is 1.

Conventional recording systems have bit aspect ratios that are considerably higher than 1, more normally between 5 and 20. High bit aspect ratios are desirable, because they result in a higher linear density and thus in a higher data rate for the recording. In addition, fabrication of the read and write heads is much easier, because the dimensions are not required to be so small. Write heads with larger dimensions are preferred, because the fields are reduced if the surface area of the head is reduced. Therefore, due to the small dimensions involved, a recording system with a patterned medium has been difficult to realize in practice and also less attractive in terms of achievable performance.

A fundamental problem of magnetic recording is scalability. In recording on BPM, each island or dot is magnetically a single domain and represents one bit. Increasing the recording density requires a reduction of the dot size. For information storage purposes, the magnetic state of the dot needs to be sufficiently stable, that is, the energy barrier that the magnetization has to overcome in a switching process has to be sufficiently greater than the thermal energy kT. The magnetic energy is given by KV, where K is the anisotropy constant (uniaxial anisotropy assumed) and V is the volume of the dot. So a decrease of the dot volume, which accompanies increasing recording density, necessitates a higher anisotropy constant K which in turn requires a higher magnetic field to switch the dots. An apparatus and method are needed to provide the higher magnetic field over a smaller area in order to use BPM materials as a recording medium, without being so intense or large enough to affect the memory state of adjacent BPM dots.

The present invention addresses all write assisted recording schemes that can be used for recording on bit-patterned media (BPM). All of these techniques address a fundamental problem of scalability in magnetic recording. In recording on bit patterned media, each island or dot is magnetically a single domain and represents one bit. Increasing the recording density requires a reduction of the dot size. For information storage purposes, the magnetic state of the dot needs to be sufficiently stable, that is, the energy barrier that the magnetization has to overcome in a switching process has to be sufficiently greater than the thermal energy kT. The magnetic energy is given by KV, where K is the anisotropy constant (uniaxial anisotropy assumed) and V is the volume of the dot. So a decrease of the dot volume, as it occurs when increasing recording density, goes along with the need of a higher anisotropy constant K which in turn means that a higher magnetic field is required to switch the dots. A write assist enables switching to higher anisotropy materials and therefore enables usage of media with smaller dots suitable for higher densities.

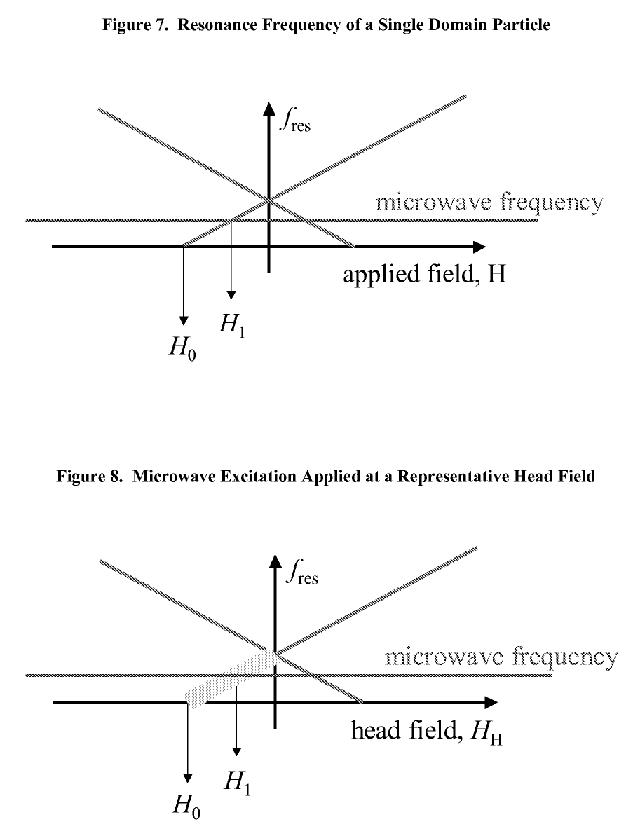

FIG. 7 sketches the resonance frequency of a single domain particle with uniaxial anisotropy as a function of applied field. The applied field is assumed to be directed along the easy axis. At zero applied field, the magnetization precesses around its equilibrium orientation with a specific resonance frequency which is called the natural precession frequency. If the applied field strength is increased, that is, the field is applied along the magnetization direction, the system becomes stiffer and the resonance frequency increases linearly with the applied field. If the applied field strength is decreased, the resonance field is decreased until it eventually reaches zero at the field at which the magnetization would switch. The additional horizontal line shows where the frequency of the additional microwave field comes to lie in the graph. The magnitude of the microwave field does not change with the “applied field”. The “applied field” is comprised of the head field and the interaction fields from all other magnetic particles. If the microwave frequency and the resonance field corresponding to the applied field match, the microwave excitation coincides with the precession frequency of the magnetization and the microwave excitation can cause the magnetization the switch. As the graph shows, the field magnitude H₁ required to switch the magnetization in the presence of the microwave excitation is much lower than that without it (H₀). This is the intended switching field assist. Obviously higher microwave frequencies are desired (but they have to remain smaller than the natural precession frequency) since they allow stronger reductions of the switching field.

It should be noted that the resonance frequency changes only linearly with the applied field if the field axis coincides with the easy axis. If the field is inclined to the easy axis, the resonance curves show curvature, but the argument remains the same. It should also be mentioned that the microwave field should be directed perpendicular to the equilibrium position of the magnetization to cause the maximum effect as it is inherent to the precessional process.

As discussed in FIG. 7, the resonance frequency of a single domain particle depends on the applied field. As mentioned before, the applied field to any single domain grain is comprised of the head field and the interaction field coming from all other particles. In conventional media, the interaction field has two components: a magnetostatic field and an exchange field. Depending on grain shape, the magnetostatic interaction field is typically between 70 and 100% of the film magnetization, which is typically between 400 and 700 kA/m for today's media. Thus one arrives at interaction fields between 280 and 700 kA/m. Additionally, there is an (opposing) intergranular exchange field which has a similar magnitude, sometimes even higher. In the context of the present invention, specifically referring to the term “applied field” in FIG. 7, these interaction fields have to be considered random. Therefore, as shown in FIG. 8, the microwave excitation applied at any given head field can cause switching in a range of particles rather than just one. The range depends on the particle's locations and their interaction fields. On the other hand, for BPM recording, the interaction fields are considerably weaker, typically in the range of max. 10% of the film magnetization and randomness introduced by them is correspondingly less. Hence the effective gradients in BPM recording with microwave assist are considerably higher than those in conventional recording. A (field) gradient is the change of the field with distance, dH/dx, where x denotes the location along the x-axis. The word effective clarifies that angle effects (relative orientation of the applied field and easy axis) are included in the gradient calculation.

With soft underlayer, the probe head fields are of the order of 600-1000 kA/m. The probe head fields should be kept as high as possible relative to the interaction fields. Therefore, a figure of merit is the ratio of (head field strength)/(interaction field strength), with this ratio being as high as possible. Assuming the head field directly under the pole of the head, a ratio of (head field strength)/(interaction field strength) being ≧10.0 is preferable.

Applicants have also discovered that the related art for microwave-assisted magnetic write heads is not suitable for the smaller dot sizes characteristic of BPM technology. Although the related art discloses that the microwave field is applied parallel or antiparallel to the head field and the easy axis, the governing physics of the magnetization precession dictates that the microwave-assisted writing of magnetic information will be more efficient if the microwave field is oriented in the plane of the medium.

If the microwave field is applied along the magnetization, there is no torque on the magnetization and the only effect of the microwave field is the increase of the applied field. In other words, the apparatus has zero efficiency. If the field is in plane, dynamic phenomena can be excited beyond the simple field increase. Fields cannot be produced with only one component, because there will always be a mixture, but of course, knowing which component is most affected will influence the design. The microwave field preferentially should be oriented along the down-track direction, which is defined as the direction in which the head moves.

It should be noted that the terminology “microwave field” used in describing the present invention may have the same meaning as “RF field” used in the related art.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art would recognize that the numerical ranges disclosed inherently support any range within the disclosed numerical ranges even though a precise range limitation is not stated verbatim in the specification because this invention can be practiced throughout the disclosed numerical ranges. A holding to the contrary would “let form triumph over substance” and allow the written description requirement to eviscerate claims that might be narrowed during prosecution simply because the applicants broadly disclose in this application but then might narrow their claims during prosecution. Where the term “plurality” is used, that term shall be construed to include the quantity of one, unless otherwise stated. The entire disclosure of the patents and publications referred in this application are hereby incorporated herein by reference. Finally, the implementations described above and other implementations are within the scope of the following claims.

1. A method of writing information to an area of a bit-patterned medium, comprising the steps of:
positioning a magnetized probe generating a magnetic probe field with respect to the area of bit-patterned medium;
applying a static magnetic field at least in the area of the bit-patterned medium to be written, said static magnetic field being oriented in accordance with the information to be written to said area of bit-patterned medium; and
applying a microwave field at least in the area of the medium to be written at a selected frequency, wherein the microwave field is preferentially oriented in the plane of the area of bit-patterned media, resulting in the writing of information onto the area of bit-patterned media.

2. The method of claim 1 wherein said step of applying a microwave field includes the step of applying a microwave field of constant amplitude and wherein said step of providing a static magnetic field includes the step of applying a static field of variable magnitude.

3. The method of claim 1 wherein said step of providing a static field of variable magnitude includes the step of providing a static field having a magnitude variable between (−Hp+ΔH) and (−Hp−ΔH) where Hp represents the magnitude of the magnetic probe field.

4. The method of claim 1, wherein the magnetic probe field is greater than 600 kA/m.

5. The method of claim 1, wherein the magnetized probe is in motion relative to the bit-patterned media, and further wherein the microwave field is directed along the direction of travel of the magnetized probe relative to the bit-patterned media.

6. The method of claim 1, wherein the microwave field is inclined relative to the easy axis of the grain of the bit-patterned media.

7. The method of claim 1, wherein the microwave field is directed perpendicular to the equilibrium position of the magnetization.
